(19) United States
(12) Patent Application Publication
(10) Pub. No.: US 2022/0396246 A1
(43) Pub. Date: Dec. 15, 2022

(54) ENHANCED VEHICLE OPERATION

(71) Applicant: Ford Global Technologies, LLC, Dearborn, MI (US)

(72) Inventors: Purushothaman Rayalsamy, Westland, MI (US); Justin T. Hughes, Allen Park, MI (US); Hao Zhang, Ann Arbor, MI (US); Aaron L. Mills, Ann Arbor, MI (US); Alex Maurice Miller, Canton, MI (US)

(73) Assignee: Ford Global Technologies, LLC, Dearborn, MI (US)

(21) Appl. No.: 17/343,856

(22) Filed: Jun. 10, 2021

(51) Int. Cl. B60T 7/12; B60Q 1/52

(52) U.S. Cl. CPC B60T 7/12; B60Q 1/525; B60Q 1/44

(57) ABSTRACT

A first distance is determined between a location of a host vehicle and a received location of a remote vehicle, the remote vehicle being forward of the host vehicle. A second distance is determined between a target vehicle and the host vehicle. A time to reach is predicted between the target vehicle and the remote vehicle based on the first distance and the second distance. A brake of the host vehicle is pre-charged when the predicted time to reach is below a time threshold. Pre-charging of the brake of the host vehicle is suppressed when the predicted time to reach is above the time threshold.

### BACKGROUND

Vehicles can be equipped with computing devices, networks, sensors and controllers to acquire data regarding the vehicle's environment and to operate the vehicle based on the data. Vehicle sensors can provide data concerning objects on a roadway, such as other vehicles. Operation of the vehicle can be based upon acquiring accurate and timely data regarding the objects while the vehicle is being operated on the roadway.

### BRIEF DESCRIPTION OF THE DRAWINGS

FIG. 1 is a block diagram of an example system for pre-charging a brake of a vehicle.

FIG. 2 is a top-down view of a host vehicle, a remote vehicle, and a target vehicle between the host vehicle and the remote vehicle.

FIG. 3 is a top-down view of the host vehicle and the remote vehicle.

FIG. 4 is a block diagram of an example process for pre-charging the brake of the vehicle.

### DETAILED DESCRIPTION

A system includes a computer including a processor and a memory, the memory including instructions executable by the processor to determine a first distance between a location of a host vehicle and a received location of a remote vehicle, the remote vehicle being forward of the host vehicle, determine a second distance between a target vehicle and the host vehicle, predict a time to reach between the target vehicle and the remote vehicle based on the first distance and the second distance, pre-charge a brake of the host vehicle when the predicted time to reach is below a time threshold, and suppress the pre-charge of the brake of the host vehicle when the predicted time to reach is above the time threshold.

The instructions can further include instructions to, upon suppressing the pre-charge of the brake of the host vehicle, actuate a forward collision subsystem of the host vehicle to provide an output when a detected distance between the host vehicle and the target vehicle is below a forward distance threshold.

The instructions can further include instructions to determine the time threshold based on the forward distance threshold and a current host vehicle speed.

The forward collision subsystem can be programmed to predict a second time to reach between the host vehicle and the target vehicle, and the instructions can further include instructions to actuate a brake of the host vehicle when the second time to reach is below a second time threshold.

The instructions can further include instructions to, upon receiving the location from the remote vehicle, determine a location of the target vehicle and, when the location of the remote vehicle and the location of the target vehicle are within a distance threshold, suppress the pre- charge of the brake of the host vehicle.

The instructions can further include instructions to, upon receiving the location from the remote vehicle, determine a location of the target vehicle and, when a distance between the location of the remote vehicle and the location of the target vehicle exceed a distance threshold, predict the time to reach between the target vehicle and the remote vehicle.

The instructions can further include instructions to predict the time to reach based on detected relative speed between the host vehicle and the target vehicle.

The instructions can further include instructions to transmit an emergency electronic brake light alert when the predicted time to reach is below the time threshold.

The instructions can further include instructions to determine the time threshold based on a predicted braking distance of the target vehicle.

The instructions can further include instructions to pre-charge the brake of the host vehicle upon determining that the target vehicle occludes the remote vehicle from detection by the host vehicle.

The instructions can further include instructions to actuate the brake of the host vehicle based on the predicted time to reach.

The instructions can further include instructions to, upon determining that the remote vehicle and the target vehicle are a same vehicle, suppress the pre-charge of the brake of the host vehicle.

A method includes determining a first distance between a location of a host vehicle and a received location of a remote vehicle, the remote vehicle being forward of the host vehicle, determining a second distance between a target vehicle and the host vehicle, predicting a time to reach between the target vehicle and the remote vehicle based on the first distance and the second distance, pre-charging a brake of the host vehicle when the predicted time to reach is below a time threshold, and suppressing the pre-charge of the brake of the host vehicle when the predicted time to reach is above the time threshold.

The method can further include, upon suppressing the pre-charge of the brake of the host vehicle, actuating a forward collision subsystem of the host vehicle to provide an output when a detected distance between the host vehicle and the target vehicle is below a forward distance threshold.

The method can further include determining the time threshold based on the forward distance threshold and a current host vehicle speed.

The forward collision subsystem can be programmed to predict a second time to reach between the host vehicle and the target vehicle, and the method can further include actuating a brake of the host vehicle when the second time to reach is below a second time threshold.

The method can further include, upon receiving the location from the remote vehicle, determining a location of the target vehicle and, when the location of the remote vehicle and the location of the target vehicle are within a distance threshold, suppressing the pre-charge of the brake of the host vehicle.

The method can further include, upon receiving the location from the remote vehicle, determining a location of the target vehicle and, when a distance between the location of the remote vehicle and the location of the target vehicle exceed a distance threshold, predicting the time to reach between the target vehicle and the remote vehicle.

The method can further include predicting the time to reach based on detected relative speed between the host vehicle and the target vehicle.

The method can further include transmitting an emergency electronic brake light alert when the predicted time to reach is below the time threshold.

The method can further include determining the time threshold based on a predicted braking distance of the target vehicle.

The method can further include pre-charging the brake of the host vehicle upon determining that the target vehicle occludes the remote vehicle from detection by the host vehicle.

The method can further include actuating the brake of the host vehicle based on the predicted time to reach.

The method can further include, upon determining that the remote vehicle and the target vehicle are a same vehicle, suppressing the pre-charge of the brake of the host vehicle.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

A vehicle (sometimes for convenience referred to as the “remote” vehicle) can transmit data to other vehicles on a roadway, including a position and speed of the first vehicle. For example, using vehicle-to-vehicle (V2V) communication, the remote vehicle can inform the other vehicles, such as a host vehicle, when the remote vehicle begins to brake, potentially slowing down traffic on the roadway. The host vehicle may not be able to detect the remote vehicle with their respective sensors, and the host vehicle may actuate components when receiving a message from the remote vehicle indicating that the remote vehicle is braking. That is, when the other vehicles, including the host vehicle, receive the message via V2V that the remote vehicle is braking, the other vehicles may actuate their respective brakes to slow or stop, even when the other vehicles do not detect the remote vehicle braking. Thus, by providing information about the remote vehicle braking, operation of the other vehicles on the roadway is improved to avoid and/or mitigate collision risk between the other vehicles and the braking remote vehicle.

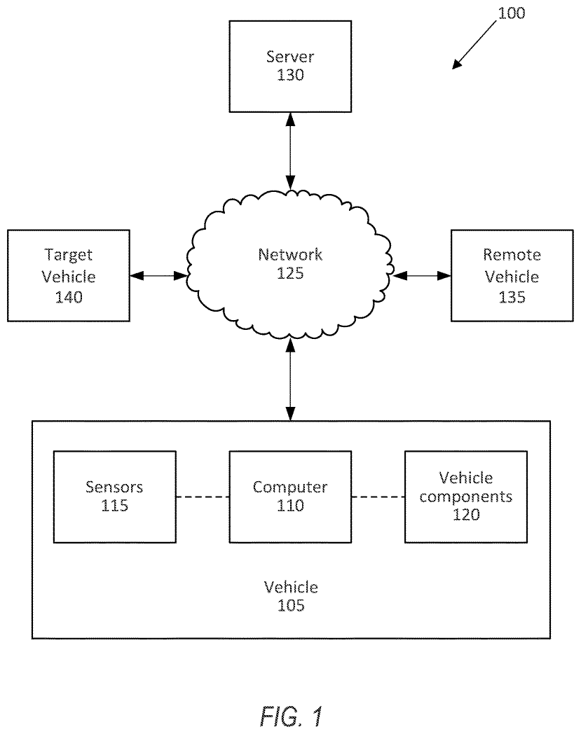

FIG. 1 illustrates an example system 100 for operating a host vehicle 105. A computer 110 in the vehicle 105 is programmed to receive collected data from one or more sensors 115. For example, vehicle 105 data may include a location of the vehicle 105, data about an environment around a vehicle, data about an object outside the vehicle such as another vehicle, etc. A vehicle 105 location is typically provided in a conventional form, e.g., geo-coordinates such as latitude and longitude coordinates obtained via a navigation system that uses the Global Positioning System (GPS). Further examples of data can include measurements of host vehicle 105 systems and components, e.g., a vehicle 105 velocity, a vehicle 105 trajectory, etc.

The computer 110 is generally programmed for communications on a vehicle 105 network, e.g., including a conventional vehicle 105 communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include an electronic control unit (ECU) or controller or the like for a specific function or set of functions and/or may include a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in computer 110.

In addition, the computer 110 may be programmed for communicating with the wide area network 125, which, as described below, may include various wired and/or wireless networking technologies, e.g., cellular, Bluetooth®, Bluetooth® Low Energy (BLE), wired and/or wireless packet networks, etc.

The memory of a computer 110 can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle 105 network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected in a vehicle 105. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, each vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 120 can include computing devices, e.g., devices typically referred to as electronic control units (ECUs) or the like and/or computing devices such as described above with respect to the computer 110, and that likewise communicate via a vehicle 105 network.

The system 100 can further include a wide area network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

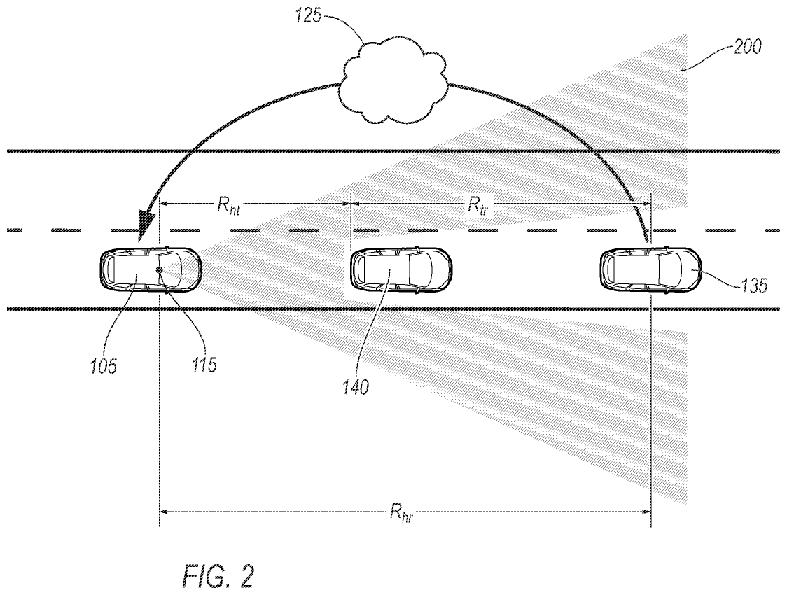

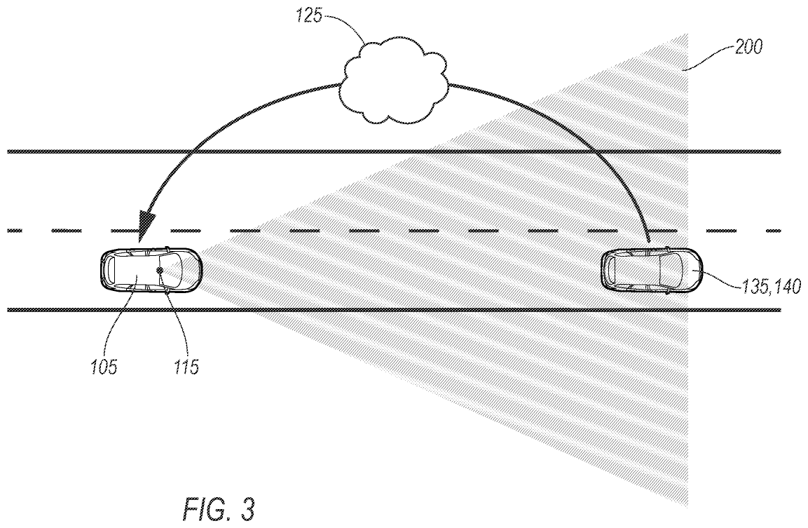

The system 100 can include a remote vehicle 135 and a target vehicle 140. A “remote” vehicle 135 is a vehicle that communicates a message with the vehicle 105, referred to herein as a “host vehicle” 105. The remote vehicle 135 can be a vehicle that the host vehicle 105 does not detect because the remote vehicle 135 is outside a detection range of sensors 115 of the host vehicle 105. The “target” vehicle 140 is a vehicle that is detected by the host vehicle 105. That is, the computer 110 collects data from one or more sensors 115, and upon detecting another vehicle, the computer 110 identifies the detected vehicle as the target vehicle 140. Thus, the remote vehicle 135 is a vehicle that communicates with the host vehicle 105 but may not be detected by the computer 110, and the target vehicle 140 is a vehicle that is detected by the computer 110 but may not communicate with the host vehicle 105. As described below and shown in FIGS. 2-3, the computer 110 can adjust operation of components 120 of the host vehicle 105 based on data received from the remote vehicle 135 and collected about the target vehicle 140.

FIG. 2 is a top-down view of a host vehicle 105, a remote vehicle 135, and a target vehicle 140. The host vehicle 105 includes a plurality of sensors 115 defining a detection zone 200 in front of the host vehicle 105. The “detection zone” is an area in which the sensors 115 can collect data to detect object such as other vehicles. The computer 110 can detect the target vehicle 140 because the target vehicle 140 is within the detection zone 200. The target vehicle 140 can block the remote vehicle 135 from detection by the sensors 115, i.e., the target vehicle 140 can reduce a size of the detection zone 200 by blocking a field of view of the sensors 115 in front of the target vehicle 140. Thus, the sensors 115 may not be able to detect the remote vehicle 135. The host vehicle 105 can receive a message from the remote vehicle 135, but the host vehicle 105 may not be able to detect the remote vehicle 135 being blocked from detection by the target vehicle 140.

The computer 110 can pre-charge a brake 120 of the host vehicle 105. To “pre-charge” the brake 120 means to increase a brake pressure of the brake 120 in preparation to brake the host vehicle 105. That is, the computer 110 can actuate a brake pump to transfer brake fluid from a reservoir to a brake actuator, increasing a pressure of the brake fluid. Thus, when the computer 110 determines to actuate the brake 120, the increased pressure of the brake fluid causes the vehicle 105 to slow faster than the brake 120 would if not pre-charged.

The computer 110 can determine whether to pre-charge the brake 120 of the host vehicle 105 based on a predicted time to reach between the remote vehicle 135 and the target vehicle 140. The “time to reach” is a predicted time that the remote vehicle 135 would reach the target vehicle 140 when the remote vehicle 135 brakes. In this context, the time to reach is a distance between the remote vehicle 135 and the target vehicle 140 divided by a speed of the target vehicle 140, as described below. To predict the time to reach, the computer 110 can receive a message from the remote vehicle 135 including data about the remote vehicle 135 and can collect data about the target vehicle 140. That is, the remote vehicle 135 can transmit messages to other vehicles, including the host vehicle 105, via V2V, the network 125, etc., indicating a current location and speed of the remote vehicle 135. The vehicles, including the host vehicle 105, can adjust operation based on the location and the speed of the remote vehicle 135. Thus, the vehicles that may not be able to detect the remote vehicle 135, including the host vehicle 105, can adjust their respective operation based on data from the remote vehicle 135. For example, the message from the remote vehicle 135 can include a brake status of the remote vehicle 135 indicating that the remote vehicle 135 is braking. When the remote vehicle 135 brakes, the target vehicle 140 may brake to avoid reaching the remote vehicle 135. Then, the host vehicle 105 may brake upon determining that the target vehicle 140 is braking. By receiving the brake status of the remote vehicle 135, the computer 110 can begin braking the host vehicle 105 before the target vehicle 140 begins to brake, slowing the host vehicle 105 and increasing an amount of time to avoid reaching the target vehicle 140 than the computer 110 would have when reacting only to the target vehicle 140. Thus, the vehicles that cannot detect the remote vehicle 135, including the host vehicle 105, can begin braking before detecting that the target vehicle 140 has begun to brake, thereby reducing collision risk.

The computer 110 can determine a distance Rₕᵣ between a location of the host vehicle 105 and a received location of the remote vehicle 135. As described above, the remote vehicle 135 transmits a message via V2V or the network 125 to other vehicles, including the host vehicle 105 and the target vehicle 140. The message includes a current location of the remote vehicle 135 in a global coordinate system, i.e., geo-coordinates. The computer 110 can determine a current location of the host vehicle 105 in the global coordinate system by, e.g., requesting location data from an external geo-coordinate server 130. The computer 110 can, using a conventional distance determining technique such as the Euclidean distance formula that calculates the distance between respective coordinates of two points in a coordinate system, determine the distance Rₕᵣ between the host vehicle 105 and the remote vehicle 135.

The computer 110 can determine a distance Rₕₜ between the host vehicle 105 and the target vehicle 140. The computer 110 can actuate one or more sensors 115 to detect the distance Rₕₜ. For example, the computer 110 can actuate a radar 115 to emit radar waves and, based on a time elapsed between emission of the radar waves, the computer 110 can determine the distance Rₕₜ between the host vehicle 105 and the target vehicle 140. Alternatively or additionally, the computer 110 can actuate one or more other sensors 115 and use one or more other conventional distance-determining techniques to determine the distance Rₕₜ, e.g., image processing of data from an image sensor 115, point cloud processing of a data cloud from a lidar 115, etc.

The computer 110 can determine a relative speed Vₕₜ between the host vehicle 105 and the target vehicle 140. As described above, the computer 110 can determine the distance Rₕₜ between the host vehicle 105 and the target vehicle 140. The computer 110 can determine the relative speed Vₕₜ as a time rate of change of the distance Rₕₜ, i.e., a range rate, between the host vehicle 105 and the target vehicle 140. For example, the computer 110 can determine a plurality of distance Rₕₜ values over a specified period of time T and can determine the relative speed Vₕₜ as an average distance value R̅ₕₜ divided by the time T:

$${\overline{R}}_{ht} = \frac{{\sum }_{i}^{N} {R}_{ht , i}}{N} ; {V}_{ht} = \frac{{\overline{R}}_{ht}}{T} \qquad ( 1 )$$

where N is the number of distance values Rₕₜ collected during the time period T and i is an integer index between 0 and N indicating a specific value of Rₕₜ.

The computer 110 can determine a speed Vₜ of the target vehicle 140 based on the relative speed Vₕₜ and a current speed Vₕ of the host vehicle 105. The computer 110 can determine the current speed Vₕ of the host vehicle 105 based on data from one or more sensors 115, e.g., a wheel speed sensor. The computer 110 can determine the speed Vₜ of the target vehicle 140 as the sum of the current speed Vₕ of the host vehicle 105 and the relative speed Vₕₜ, i.e., Vₜ=Vₕ+Vₕₜ. As described below, the computer 110 can determine the time to reach based on the speed Vₜ of the target vehicle 140.

The computer 110 can predict the time to reach TTR between the target vehicle 140 and the remote vehicle 135 based on the distances Rₕᵣ, Rₕₜ and the speed Vₜ of the target vehicle 140. Based on the distances Rₕᵣ, Rₕₜ, the computer 110 can determine a distance Rₜᵣ between the remote vehicle 135 and the target vehicle 140. The computer 110 can then determine the time to reach TTR as the distance Rₜᵣ divided by the speed Vₜ of the target vehicle 140:

$${R}_{tr} = {R}_{hr} - {R}_{ht} \qquad ( 2 )$$

$$TTR = \frac{{R}_{tr}}{{V}_{t}} \qquad ( 3 )$$

The computer 110 can compare the predicted time to reach to a time threshold. The time threshold is a specified time beyond which the target vehicle 140 is predicted to collide with the remote vehicle 135. The time threshold can be determined based on empirical testing of virtual test vehicles, i.e., simulation(s), including a first virtual test vehicle (representing the target vehicle 140) and a second virtual test vehicle (representing the remote vehicle 135). The empirical testing can include modeling the virtual test vehicles at a plurality of speeds, including determining braking distances and braking times for the test vehicles at each of the plurality of speeds. The time threshold can be a minimum time that the first virtual vehicle braked and did not collide with the second virtual vehicle. Alternatively or additionally, the time threshold can be a predicted braking distance of the first virtual test vehicle determined by the empirical testing described above divided by a current speed of the target vehicle 140 detected by the sensors 115 of the host vehicle 105. The time threshold is thus calibratable to account for the predicted amount of time, represented by the time to reach, that the target vehicle 140 has to brake in response to the remote vehicle 135.

When the predicted time to reach is below the time threshold, the computer 110 can pre-charge the brake 120, as described above. When the predicted time to reach is above the time threshold, the computer 110 can actuate a forward collision warning (FCW) subsystem. The FCW subsystem is programmed to provide an output when a detected distance between the host vehicle 105 and the target vehicle 140 is below a forward distance threshold. The forward distance threshold can be determined based on empirical testing such as described above. The computer 110 can determine the time threshold based on the forward distance threshold and a current host vehicle speed. The forward collision subsystem can predict a second time to reach between the host vehicle 105 and the target vehicle 140, e.g., based on the distance Rₕₜ described above. The computer 110 actuate a brake of the host vehicle 105 when the second time to reach is below a second time threshold. That is, the FCW subsystem can mitigate and/or avoid collision risk between the host vehicle 105 and the target vehicle 140 based on the second time to reach. The FCW subsystem provides actuation and alerts in response to detected target vehicles 140 and may not provide alerts in response to actions of remote vehicles 135 undetected by the computer 110. The FCW subsystem may respond more quickly than the pre-charged brake 120, and the computer 110 can determine to use the FCW subsystem when, based on the time threshold, the target vehicle 140 slows or stops in response to the remote vehicle 135 slowing or stopping.

Additionally or alternatively, the computer 110 can pre-charge the brake 120 of the host vehicle 105 upon determining that the target vehicle 140 occludes the remote vehicle 135 from detection by the host vehicle 105. In this context, to “occlude” the remote vehicle 135 means that the target vehicle 140 blocks one or more sensors 115 of the host vehicle 105 from detecting the remote vehicle 135. For example, the target vehicle 140 can block radar waves emitted by a radar 115 that would detect the remote vehicle 135 if the target vehicle 135 were not present. The computer 110 can determine that the target vehicle 140 is occluding the remote vehicle 135 when the computer 110 receives a message including a location of the remote vehicle 135 that is not within the detection zone 200 of the sensors 115. That is, the computer 110 can detect vehicles around the host vehicle 105 with the sensors 115 and can identify respective locations for each vehicle, including the target vehicle 140. Then, upon receiving the message and the location of the remote vehicle 135, the computer 110 can determine whether the received location is a same location as one of the locations of the vehicles. If the received location is not a same location as one of the locations of the vehicles, the computer 110 can determine that the target vehicle 140 is occluding the remote vehicle 135 from detection. Then, the computer 110 can pre-charge the brake 120.

Additionally or alternatively, the computer 110 can actuate the pre-charged brake 120 of the host vehicle 105 based on the predicted time to reach. When the remote vehicle 135 applies a brake, the target vehicle 140 applies a brake to slow or stop the target vehicle 140 before the time to reach elapses, i.e., to avoid reaching the remote vehicle 135. The computer 110, which does not detect the remote vehicle 135, can actuate the brake 120 to slow or stop the host vehicle 105 to avoid reaching the target vehicle 140. Because the target vehicle 140 would stop before the time to reach elapses, the computer 110 can also actuate the brake 120 to slow or stop the host vehicle 105 before the time to reach elapses. That is, the computer 110 can determine that the target vehicle 140 would likely stop before the time to reach elapses, which may be earlier than the computer 110 predicts that the target vehicle 140 would stop according to a conventional traffic flow algorithm. To avoid reaching the target vehicle 140, upon determining that the target vehicle 140 is beginning to brake, the computer 110 can actuate the brake 120 of the host vehicle 105 at a higher brake pressure than that computer 110 would if the computer 110 did not predict the time to reach, stopping the host vehicle 105 more quickly and avoiding reaching the target vehicle 140.

Yet alternatively or additionally, the computer 110 can transmit an emergency electronic brake light (EEBL) alert. The EEBL alert is a transmission of a message via V2V or the like, and/or via the network 125 to other vehicles indicating that the remote vehicle 135 is braking. That is, the EEBL alert provides the message for vehicles that cannot detect the host vehicle 105. The EEBL alert may thus allow computers of vehicles, including the computer 110 of the host vehicle 105, to preemptively slow and/or stop when the remote vehicle 135 brakes.

FIG. 3 is a view of the host vehicle 105 and the remote vehicle 135 with no target vehicle 140 therebetween. That is, the computer 110 can detect the remote vehicle 135 in the detection zone 200 of one or more sensors 115. In the example of FIG. 3, the remote vehicle 135 that sends the message to the computer 110 via V2V or the network 125 and the target vehicle 140 that is detected by the sensors 115 are a same vehicle. That is, the computer 110 defines a “remote” vehicle 135 as a vehicle from which a message is received via V2V or the network 125, and the computer 110 defines a “target” vehicle 140 as a vehicle detected by one or more sensors 115 of the host vehicle 105. The vehicle that sends the message via V2V or the network 125 (i.e., the remote vehicle 135) may be the same vehicle as a vehicle immediately in front of the host vehicle 105 and detected by the host vehicle 105 (i.e., the target vehicle 140). Thus, the computer 110 can determine whether to pre-charge the brake 120 when the remote vehicle 135 and the target vehicle 140 are the same vehicle.

The computer 110 can determine that the remote vehicle 135 and the target vehicle 140 are the same vehicle based on the location received from the remote vehicle 135. The computer 110 can receive a message via V2V or the network 125 including a location of the remote vehicle 135. The computer 110 can determine a location of the vehicle in front of the host vehicle 105 (i.e., the target vehicle 140) based on data from one or more sensors 115. The computer 110 can determine a distance between the received location of the remote vehicle 135 and the detected location of the target vehicle 140. For example, the computer 110 can determine the distance based on the Euclidean distance formula between the received location and the detected location. When the distance exceeds a distance threshold, the computer 110 can determine that the remote vehicle 135 is not the same vehicle as the target vehicle 140 and can predict the time to reach, as described above. When the distance is below the distance threshold, the computer 110 can determine that the remote vehicle 135 and the target vehicle 140 are the same vehicle. The distance threshold can be determined based on a length dimension of a typical vehicle, e.g., two meters. That is, when the distance is below the distance threshold, the received location and the detected location would be on a same vehicle rather than two different vehicles, so the computer 110 can determine that the received and detected locations indicate a same vehicle.

Upon determining that the remote vehicle 135 and the target vehicle 140 are the same vehicle, the computer 110 can suppress pre-charging of the brake 120. Upon suppressing pre-charge of the brake 120, the computer 110 can actuate the FCW subsystem, as described above, to predict a collision between the host vehicle 105 and the target vehicle 140. As described above, the FCW subsystem can perform actuation of the components 120 based on detected target vehicles 140 but not undetected remote vehicles 135. Thus, the computer 110 can actuate the FCW subsystem when the remote vehicle 135 and the target vehicle 140 are the same vehicle.

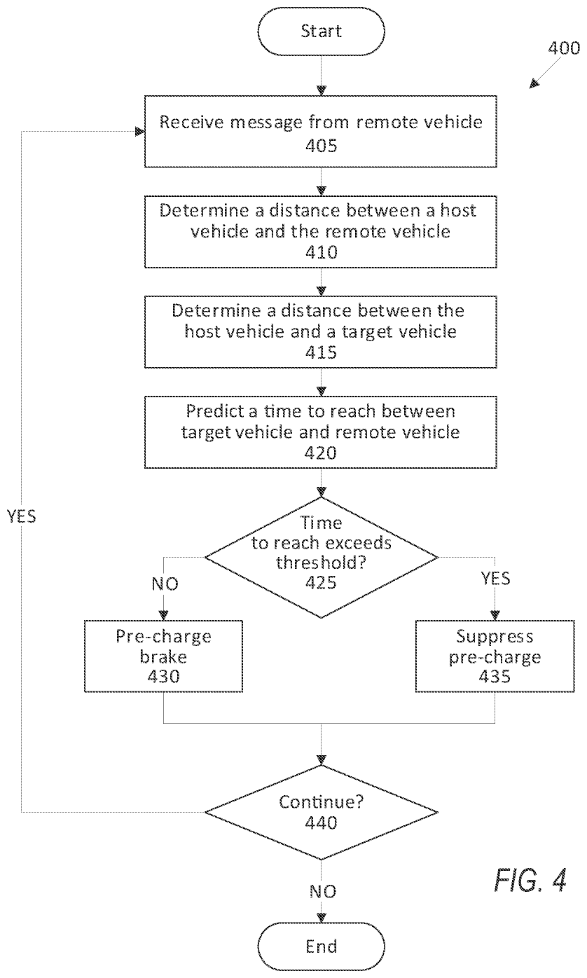

FIG. 4 is a block diagram of an example process 400 for pre-charging a brake 120 of a host vehicle 105. The process 400 begins in a block 405, in which a computer 110 of the host vehicle 105 receives a message via a network 125 from a remote vehicle 135. As described above, the remote vehicle 135 can send the message to other vehicles via V2V or the network 125 when the remote vehicle 135 brakes.

Next, in a block 410, the computer 110 determines a distance Rₕᵣ between a location of the host vehicle 105 and a location of the remote vehicle 135. As described above, the message from the remote vehicle 135 can include the location of the remote vehicle 135, and the computer 110 can determine the distance Rₕᵣ based on, e.g., the Euclidean distance formula between the location of the remote vehicle 135 and the location of the host vehicle 105.

Next, in a block 415, the computer 110 determines a distance Rₕₜ between the location of the host vehicle 105 and a location of a target vehicle 140. As described above, the target vehicle 140 is a vehicle detected by one or more sensors 115 of the host vehicle 105. For example, the computer 110 can actuate a radar 115 and detect the target vehicle 140 within a detection zone of the radar 115. The computer 110 can determine the distance Rₕₜ based on the data collected by the sensors 115, e.g., based on the collected radar waves emitted from the radar 115.

Next, in a block 420, the computer 110 predicts a time to reach TTR between the target vehicle 140 and the remote vehicle 135. As described above, the time to reach TTR is a predicted time for the target vehicle 140 to stop upon detecting the remote vehicle 135 stopping. That is, the predicted time to reach TTR is a predicted time for the target vehicle 140 to travel the distance Rᵣₜ between the remote vehicle 135 and the target vehicle 140 at a current speed Vₜ of the target vehicle 140. The computer 110 can determine the distance Rᵣₜ based on the distances Rₕᵣ, Rₕₜ, as described above, and the computer 110 can determine the speed Vₜ based on data collected by the sensors 115.

Next, in a block 425, the computer 110 determines whether the time to reach TTR exceeds a predetermined time threshold. As described above, the time threshold can be a calibratable value based on conventional braking distances and vehicle simulation modeling. If the predicted time to reach exceeds the time threshold, the process 400 continues in a block 435. Otherwise, the process 400 continues in a block 430.

In the block 430, the computer 110 pre-charges a brake 120. As described above, the computer 110 can increase a pressure of brake fluid in a brake actuator in preparation of braking the host vehicle 105. That is, the computer 110 can actuate a brake pump to transfer brake fluid from a reservoir to the brake actuator to increase the pressure of the brake fluid. Following the block 430, the process 400 continues in a block 440.

In the block 435, the computer 110 suppresses the brake pre-charge and actuates a forward collision warning subsystem. As describe above, the FCW subsystem actuates a brake of the host vehicle 105 to slow or stop the host vehicle 105 based on the distance to the target vehicle 140. The FCW subsystem thus can mitigate or avoid collision risk between the host vehicle 105 and the target vehicle 140. Following the block 435, the process 400 continues in a block 440.

In the block 440, the computer 110 determines whether to continue the process 400. For example, the computer 110 can determine to continue the process 400 while the host vehicle 105 remains on a roadway. If the computer 110 determines to continue, the process 400 returns to the block 405. Otherwise, the process 400 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

Ordinal adjectives such as “first” and “second” are used throughout this document as identifiers and are not intended to signify importance or order.

1. A system, comprising a computer including a processor and a memory, the memory including instructions executable by the processor to:
determine a first distance between a location of a host vehicle and a received location of a remote vehicle, the remote vehicle being forward of the host vehicle;
determine a second distance between a target vehicle and the host vehicle;
predict a time to reach between the target vehicle and the remote vehicle based on the first distance and the second distance;
pre-charge a brake of the host vehicle when the predicted time to reach is below a time threshold; and
suppress the pre-charge of the brake of the host vehicle when the predicted time to reach is above the time threshold.

2. The system of claim 1, wherein the instructions further include instructions to, upon suppressing the pre-charge of the brake of the host vehicle, actuate a forward collision subsystem of the host vehicle to provide an output when a detected distance between the host vehicle and the target vehicle is below a forward distance threshold.

3. The system of claim 2, wherein the instructions further include instructions to determine the time threshold based on the forward distance threshold and a current host vehicle speed.

4. The system of claim 2, wherein the forward collision subsystem is programmed to predict a second time to reach between the host vehicle and the target vehicle and the instructions further include instructions to actuate a brake of the host vehicle when the second time to reach is below a second time threshold.

5. The system of claim 1, wherein the instructions further include instructions to, upon receiving the location from the remote vehicle, determine a location of the target vehicle and, when the location of the remote vehicle and the location of the target vehicle are within a distance threshold, suppress the pre-charge of the brake of the host vehicle.

6. The system of claim 1, wherein the instructions further include instructions to, upon receiving the location from the remote vehicle, determine a location of the target vehicle and, when a distance between the location of the remote vehicle and the location of the target vehicle exceed a distance threshold, predict the time to reach between the target vehicle and the remote vehicle.

7. The system of claim 1, wherein the instructions further include instructions to predict the time to reach based on detected relative speed between the host vehicle and the target vehicle.

8. The system of claim 1, wherein the instructions further include instructions to transmit an emergency electronic brake light alert when the predicted time to reach is below the time threshold.

9. The system of claim 1, wherein the instructions further include instructions to determine the time threshold based on a predicted braking distance of the target vehicle.

10. The system of claim 1, wherein the instructions further include instructions to pre-charge the brake of the host vehicle upon determining that the target vehicle occludes the remote vehicle from detection by the host vehicle.

11. The system of claim 1, wherein the instructions further include instructions to actuate the brake of the host vehicle based on the predicted time to reach.

12. The system of claim 1, wherein the instructions further include instructions to, upon determining that the remote vehicle and the target vehicle are a same vehicle, suppress the pre-charge of the brake of the host vehicle.

13. A method, comprising:
determining a first distance between a location of a host vehicle and a received location of a remote vehicle, the remote vehicle being forward of the host vehicle;
determining a second distance between a target vehicle and the host vehicle;
predicting a time to reach between the target vehicle and the remote vehicle based on the first distance and the second distance;
pre-charging a brake of the host vehicle when the predicted time to reach is below a time threshold; and
suppressing the pre-charge of the brake of the host vehicle when the predicted time to reach is above the time threshold.

14. The method of claim 13, further comprising, upon suppressing the pre-charge of the brake of the host vehicle, actuating a forward collision subsystem of the host vehicle to predict a collision between the host vehicle and the target vehicle.

15. The method of claim 13, further comprising, upon receiving the location from the remote vehicle, determining the location of the target vehicle and, when the location of the remote vehicle and the location of the target vehicle are within a distance threshold, suppressing pre-charge of the brake of the host vehicle.

16. The method of claim 13, further comprising, upon receiving the location from the remote vehicle, determining a location of the target vehicle and, when a distance between the location of the remote vehicle and the location of the target vehicle exceed a distance threshold, predicting the time to reach between the target vehicle and the remote vehicle.

17. The method of claim 13, further comprising predicting the time to reach based on a detected relative speed between the host vehicle and the target vehicle.

18. The method of claim 13, further comprising transmitting an emergency electronic brake light alert when the predicted time to reach is below the time threshold.

19. The method of claim 13, further comprising determine the time threshold based on a predicted braking distance of the target vehicle.

20. The method of claim 13, further comprising pre-charging the brake of the host vehicle upon determining that the target vehicle occludes the remote vehicle from detection by the host vehicle.
